(19) United States
(12) Patent Application Publication
(10) Pub. No.: US 2018/0276142 A1
(43) Pub. Date: Sep. 27, 2018

(54) FLUSHES AFTER STORAGE ARRAY EVENTS

(71) Applicant: Hewlett Packard Enterprise Development LP, Houston, TX (US)

(72) Inventors: Joseph E. Algieri, Santa Clara, CA (US); John J. Sengenberger, Meridian, ID (US); Siamak Nazari, Mountain View, CA (US)

(21) Appl. No.: 15/467,039

(22) Filed: Mar. 23, 2017

(51) Int. Cl. G06F 12/128; G06F 3/06; G06F 12/0808

(52) U.S. Cl. CPC G06F 12/128; G06F 3/0689; G06F 12/0808; G06F 2212/621; G06F 3/0665; G06F 2212/69; G06F 3/0619

(57) ABSTRACT

Examples discussed herein include receiving a notification about an event occurring in a storage array. In response to receiving the notification a cache of the storage array may be frozen and the data in the cache may be flushed to a persistent storage. The data in the cache is stored in the cache prior to the event. Examples also include receiving first data in a first host write request that is received after the event from a host device, sending a write request complete signal to the host device, and flushing the first data to the persistent storage. The first data is flushed after the data in cache is flushed.

### BACKGROUND

A storage array generally includes a cluster of controller nodes with a large data cache. The array may be communicatively linked to persistent storage, and to host devices, that may write to and read from the persistent storage presented by the storage array. For the sake of robustness of a data center, the storage array may provide mechanisms for protecting the data that flows through the storage array.

### BRIEF DESCRIPTION

Some examples are described with respect to the following figures:

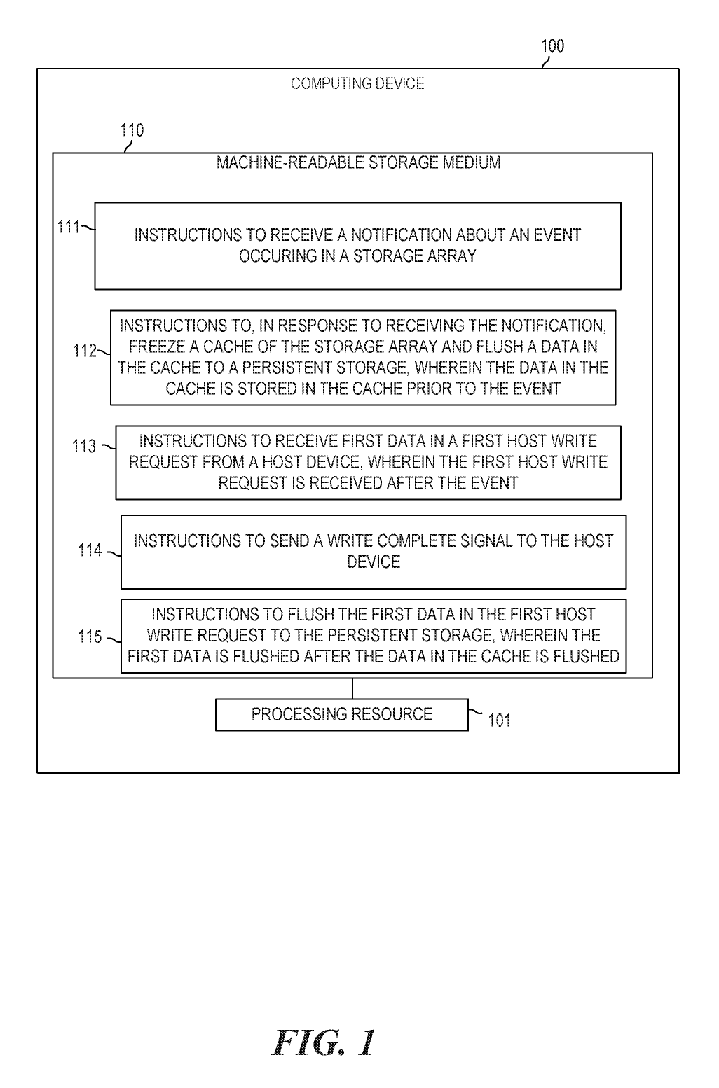

FIG. 1 is a block diagram of a computing device to flush cache data after an occurrence of a storage array event, according to some examples.

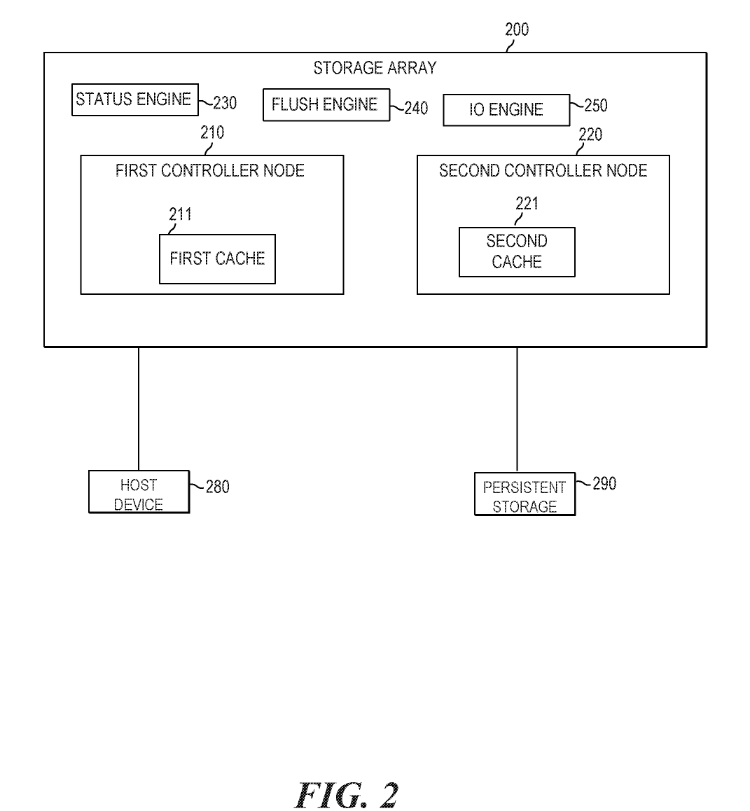

FIG. 2 is a block diagram of a storage array with a flush engine, an IO engine, a first controller node, and a second controller node, according to some examples.

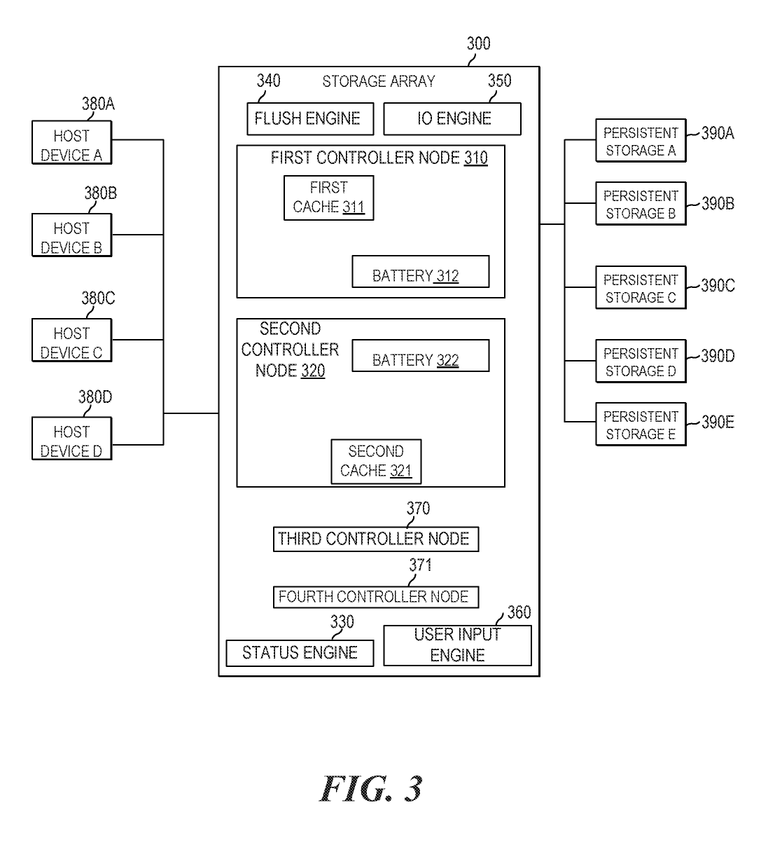

FIG. 3 is a block diagram of a storage array with multiple controller nodes associated with batteries, according to some examples.

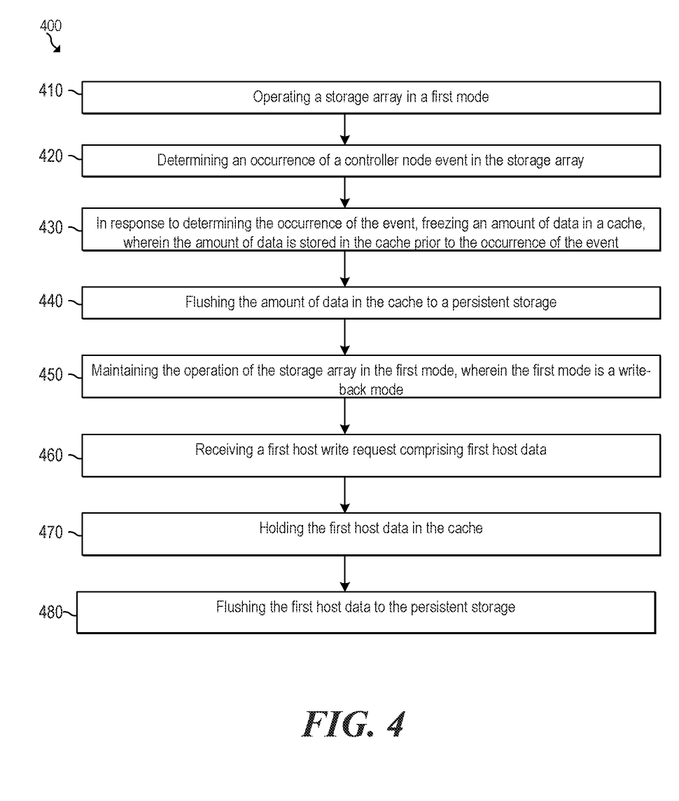

FIG. 4 is a flowchart of a method of flushing cache data after an occurrence of a storage array event, according to some examples.

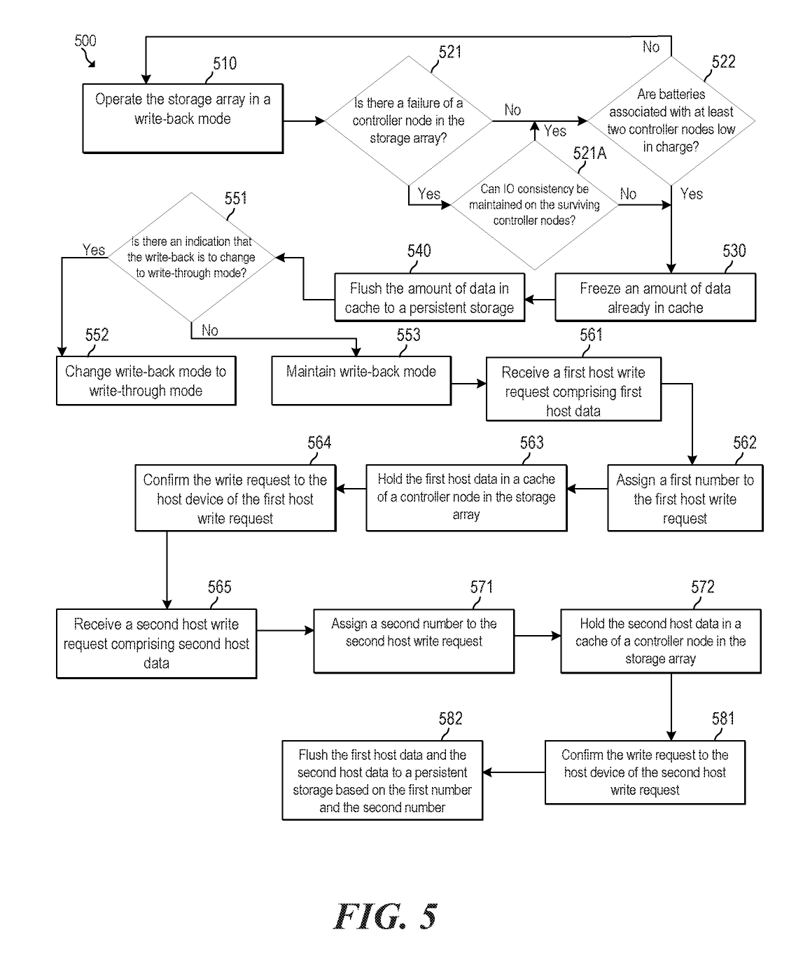

FIG. 5 is a flowchart of a method of flushing new host requests after an occurrence of a storage array event, according to some examples.

### DETAILED DESCRIPTION

A storage array may have a number of controller nodes that cooperate with each other to process host write requests. For example, a host write request may be duplicated (mirrored) on multiple nodes before being acknowledged to the host and before being committed to persistent storage. A storage array may also be operated in different modes, including write-through mode and write-back mode. In write-through mode, in some examples, new write requests are cached into a write cache of the storage array and written to the persistent storage before a write complete may be sent to the host device that initiated the write request. In write-back mode, in some examples, a write complete may be sent to the host after the data is duplicated into a write cache of two nodes on the storage array. Generally, write-back mode may allow for better performance of the storage array due to decreased latency as compared to write-through mode.

IO consistency for a logical volume on a storage array is generally a combination of data that resides in the cache of a storage array and data that resides on the persistent storage. Accordingly, flushing algorithms in storage arrays using write-back modes do not flush data in a manner that ensures IO consistency for the data on the persistent storage. For example, later-requested write request may be flushed before an earlier-requested write request is flushed. However, in the event a problem occurs in the storage array (for example, a failure of a node in the storage array or a low battery in battery-backed caches of the storage array), these flushing algorithms may cause IO inconsistencies in the logical volume. For example, a logical volume may consist of write requests N, N+1, N+2, N+3, and N+4. Prior to the problem in the storage array, N+4, N+2, and N may have been flushed to persistent storage, while N+1, and N+3 remain in cache. While N+1, and N+3 may be duplicated in the caches of a first controller node and a second controller node, a failure of the first controller node means that only the cache of the second controller node is accessible. A storage array that remains in write-back mode after the failure of the first controller node may add additional write requests, N+5, N+6, etc. to its cache. These “new” write requests, which occurred after the problem in the storage array, may then be flushed to the persistent storage before N, N+1, and N+3. In the event the second controller node also fails, the logical volume including N−N+6 is inconsistent because only write requests N, N+2, and N+4 reside on the persistent storage. Accordingly, these storage arrays may switch to a write-through mode when a problem occurs in the storage node in an effort to avoid this problem. This switch leads to decreased storage array performance due to increased latency.

Examples disclosed herein address these technological issues by allowing a storage array to maintain IO consistency using write-back mode after a problem that affects a controller node in the storage array. Upon a detection of a problem in the storage array, the data already existing in cache of the storage array is frozen such that it cannot be altered. The frozen cache data is treated as a set and flushed to a persistent storage. New, incoming host write requests are assigned a unique number to indicate the order in which they are received. These, new write requests are cached, and flushed according to the number they were assigned. Thus, these examples disclosed herein allow a storage array to maintain the low latency and high performance associated with write-back mode while ensuring IO consistency for the data stored on the persistent memory.

In some examples, a non-transitory machine-readable storage medium with instructions is provided. The instructions, when executed, cause a processing resource to receive a notification about an event occurring in a storage array and, in response to receiving the notification, freeze a cache of the storage array and flush data in the cache to a persistent storage. The instructions, when executed, also cause the processing resource to receive first data in a first host write request from a host device, send a write request complete signal to the host device, and flush the first data to the persistent storage. The data in the cache is stored in the cache prior to the event, the first host write request is received after the event, and the first data is flushed after the data in cache prior to the event is flushed.

In some examples, a storage array is provided including a first controller node, a second controller node, a status engine, a first cache, a flush engine, and an IO engine. The status engine is to determine an occurrence of a controller node event in the storage array. The first cache is to hold a first amount of data that is generated before the occurrence of the controller node event. The flush engine is to freeze the first amount of data in the first cache upon occurrence of the controller node event and to flush the first amount of data to a persistent storage. The IO engine is to receive a first host request comprising first host data and to assign a number to the first host request. The first host request is received after the occurrence of the controller node event.

In some examples, a method is provided including operating a storage array in a first mode, determining an occurrence of a controller node event in the storage array. The method also includes, freezing, in response to determining the occurrence of the event, an amount of data in a cache, flushing the amount of data in the cache to a persistent storage, maintaining the operation of the storage array in the first mode, receiving a first host request comprising first host data, holding the first host data in the cache, and flushing the first host data to the persistent storage. The amount of data is generated prior to the occurrence of the event and the first mode is a write-back mode.

The following terminology is understood to mean the following when recited by the specification or the claims. The singular forms “a,” “an,” and “the” mean “at least one.” The terms “including” and “having” have the same inclusive meaning as the term “comprising.”

Referring now to the figures, FIG. 1 is a block diagram of a computing device 100 to flush cache data after an occurrence of a storage array event. As used herein, a “computing device” may be a web-based server, a local area network server, a cloud-based server, computer networking device, chip set, desktop computer, workstation, or any other processing device or equipment. In some examples, computing device 100 may be a storage array. In some examples, the storage array may include a first controller node and a second controller node that interact with each other to process a data request of a host device (not shown in FIG. 1). For example, when a host device issues a write request, the data is sent to the storage array, processed in the storage array, and then committed to a persistent storage that interacts with storage array. As used herein, a controller node may be a computing device that is capable of communicating with at least one host device and/or with at least one persistent storage. In some examples, multiple controller nodes (e.g., two controller nodes) may be implemented by the same computing device. In general, a controller node may monitor the state of the persistent storage and may handle requests by host devices to access the persistent storage via various physical paths. Thus, in some examples, a cluster of controller nodes allows computing device 100 to present to a host device a single pool of storage from multiple persistent storages.

Computing device 100 includes a processing resource 101 and a machine-readable storage medium 110. Machine-readable storage medium 110 may be in the form of non-transitory machine-readable storage medium, such as suitable electronic, magnetic, optical, or other physical storage apparatus to contain or store information such as instructions 111, 112, 113, 114, 115, related data, and the like.

As used herein, “machine-readable storage medium” may include a storage drive (e.g., a hard drive), flash memory, Random Access Memory (RAM), any type of storage disc (e.g., a Compact Disc Read Only Memory (CD-ROM), any other type of compact disc, a DVD, etc.) and the like, or a combination thereof. In some examples, a storage medium may correspond to memory including a main memory, such as a Random Access Memory, where software may reside during runtime, and/or a secondary memory. The secondary memory can, for example, include a nonvolatile memory where a copy of software or other data is stored.

In the example of FIG. 1, instructions 111, 112, 113, 114, and 115 are stored (e.g., encoded) on storage medium 110 and are executable by processing resource 101 to implement functionalities described herein in relation to FIG. 1. In some examples, storage medium 110 may include additional instructions, like, for example, the instructions to implement some of the functionalities described in relation to storage array 300 of FIG. 3. In some examples, the functionalities of any of the instructions of storage medium 110 may be implemented in the form of electronic circuitry, in the form of executable instructions encoded on machine-readable storage medium, or a combination thereof.

Processing resource 101 may, for example, be in the form of at least one central processing unit (CPU), a semiconductor-based microprocessor, a digital signal processor (DSP) such as a digital image processing unit, other hardware devices or processing elements suitable to retrieve and execute instructions stored in a storage medium, or suitable combinations thereof. The processing resource can, for example, include single or multiple cores on a chip, multiple cores across multiple chips, multiple cores across multiple devices, or suitable combinations thereof. The processing resource can be functional to fetch, decode, and execute instructions 111, 112, 113, 114, and 115, as described herein.

Instructions 111 may be executable by processing resource 101 such that computing device 100 receives a notification about an event occurring in a first controller node of a storage array. As used herein, an event may include any event that results in the cache of a controller node in the storage array being inaccessible or unreliable. For example, an event may include a failure of a controller node in the storage array. This may include a failure of one controller node in a storage array, two controller nodes in a storage array, etc. As another example, an event may include the low charge of the battery associated with at least two controller nodes in the storage array (e.g., in a storage array with two controller nodes, the event may include the batteries associated with both controller nodes having a low charge) For example, controller nodes in the storage array may have caches that are battery-backed. This allows the caches to be flushed during a complete power failure to the controller nodes. However, the charges on the batteries may be depleted during the power failure. When power is returned to the controller nodes, the batteries may need some time to re-charge and thus does not have enough charge to withstand a second power failure and be able to flush dirty cache. During this time, when the batteries have a low charge, the caches on the controller nodes are unreliable because a second power failure will result in the data in the caches being inaccessible. Accordingly, instructions 111 allow computing device 100 to receive a notification when such an event occurs in the storage array.

Instructions 112 may be executable by processing resource 101 such that computing device 100 freezes a cache of the storage array and flushes data in the cache to a persistent storage. The freezing and the flushing of the cache data is done in response to receiving the notification that an event has occurred in the storage array. A cache of a storage array may include a cache in any one of the storage array's controller nodes. For example, a first controller node of a storage array may include a cache (e.g., non-volatile random access memory, etc.) where data from a host write request is temporarily held before the data is committed to a persistent storage. As another example, a second controller node may also have a cache, and a third controller node may also have a cache. A storage array's cache (thus a cache of any controller node in the storage array) may include any number of cache pages. These cache pages may include data from host write requests that occurred before the event. Accordingly, the data in cache at the time of the occurrence of the event is generated prior to the event. In response to a determination that an event has occurred in the storage array, the existing pages in the storage array's cache are frozen such that they cannot be altered. The pages are then flushed to a persistent storage. This helps to ensure that the data stored in the persistent storage is consistent and represents a complete logical unit of the storage array in case another storage array event occurs.

For example, a complete logical unit of the storage array may include host write requests that occurred at N−1, N, N+1, N+2, and N+3. The data from these requests are stored in cache of the storage array before being flushed to a persistent storage. In some examples, in a storage array where no event has occurred, the flushing of the data to the persistent storage does not occur in the order that the host write requests are received by the storage array. For example, data associated with host write requests N, and N+3 may be flushed to persistent storage while the data associated with host write requests N−1, N+1 and N+2 may remain in cache. Upon the occurrence of an event (e.g., a controller node fails in a storage array with two controller nodes or a low charge of the batteries associated with both controller nodes), another occurrence of an event may mean that the data remaining in cache may be lost (e.g., failure of the one remaining controller node in a storage array with two controller nodes or a second power failure). This may result in logical unit inconsistency for the logical unit with N−1, N, N+1, N+2, and N+3 because while N and N+3 are stored on the persistent storage, N−1, N+1 and N+2 may be lost. Freezing the data already existing in cache and immediately flushing that data upon the occurrence of the event ensures that the data already existing in cache is the next data that is flushed to persistent storage. This allows for a higher likelihood that N−1, N+1 and N+2 will be flushed before another event occurs that results in the losing of N−1, N+1 and N+2. Without the freezing and immediate flushing of the already-existing cache data, the storage array may flush host write requests that are received after the event, resulting in a higher likelihood that N−1, N+1 and N+2 will not be flushed before another event occurs.

Instructions 113 may be executed by processing resource 101 such that computing device 100 receives first data in a first host write request. This first host write request is generated (e.g., received by the computing device 100) after the event. For example, after the event occurs, computing device 100 may receive a write request from a host device attached to the storage array. This write request may be a request to store new data to a persistent storage. Instructions 113 may also include instructions to receive data in additional host write requests after the first host write request, for example, second data in a second host write request, third data in a third host write request, etc. In some examples, instructions 113 may also include instructions to assign a unique identifier to first host write request and a unique identifier to any additional host write requests that is received by the storage array. These identifiers indicate the order in which the host write requests are received by the storage array. These identifiers are universal to the host write requests across the storage array. In some examples, the identifiers are stored as part of the metadata for the LUN and is associated with the host write request for the LUN. In some examples, the identifiers are numbers. While examples disclosed herein describe these identifiers as numbers, other types of characters may be used as identifiers (such as alphanumeric characters, etc.)

For example, a storage array may include a number of controller nodes, e.g., a first controller node, a second controller node, a third controller node, etc. The storage array may also interact with a number of host devices. After the event occurs, a host write request may be initiated by any one of the number of host devices and processed by any one of the number of controller nodes. Host device A may initiate a host write request, which may be processed by a first controller node. Host device B may then initiate a host write request, which may be processed by a second controller node. Host device A may then initiate another host write request, which may be processed by a third controller node. Even though these write requests are processed by different controller nodes in the storage array, the numbers assigned by computing device 100 to the write requests reflect the order in which they are received by the storage array. Thus, the host write request that is processed by the first controller node may be assigned number 1, since it was received first. The host write request that is processed by the second controller node may be assigned number 2. This is because even though it was the first host write request processed by second controller node, it is the second host write request received by the storage array. Likewise, the host write request processed by the third controller node may be assigned number 3, since it was received third (even though it was the first host request processed by the third controller node). Accordingly, the numbers assigned to the host write requests indicate an order in which they are received across all controller nodes in the storage array.

Instructions 113 may also include instructions to hold the data received in the host write requests in a cache of the storage array. For example, the first data in the first host write request may be held in a cache of any controller node of the storage array (e.g., the first controller node, the second controller node, etc.). Instructions 113 may also include instructions to hold any data received in additional host write requests in a cache of the storage array. The numbers that are assigned to the first host write request carry over into the cache in which they are held.

Instructions 114 may be executable by processing resource 101 such that computing device 100 sends a write request complete signal (i.e. an IO complete) to the host device that initiated the first host write request. This signal alerts the host device that its request to store the first host data is finished and allows the host device to initiate another host write request. In some examples, without this complete signal, the host device does not initiate another host write request. In some examples, instructions 114 also include instructions to send write request complete signals for any additional write host requests that are received by the storage array.

Instructions 115 may be executable by processing resource 101 such that computing device 100 flushes the first data in the first host write request to the persistent storage. For example, computing device 100 may control the flushing activity of the storage array. It may send a signal to a controller node that is holding first data in its cache, telling the controller node to flush the first data to the persistent storage. In some examples, instructions 115 also include instructions to flush data from additional host write requests that is being temporarily held in cache. In these examples with additional host write requests, the order in which the data is flushed is based, in part, by the number that is assigned to the host write requests. For example, data that is associated with a host write request assigned number 2 is flushed before data that is associated with a host write request assigned number 3 and after data that is associated with a host write request assigned number 1. The first data and any other data from additional host write requests is flushed after the data already-existing in cache prior to the occurrence of the event is flushed.

The flushing mechanism described in relation to FIG. 1 may allow for a storage array in which an event has occurred to continue to operate in a write-back mode and maintain IO consistency for its logical units. Upon an occurrence of an event, data already-existing in cache is frozen and flushed to the persistent storage. This data is flushed before data in any new host write request is flushed from cache. The flushing of this already-existing cache data allows for 10 consistency with regard to “old” host write requests (i.e. write requests generated before the event) in case another storage array event occurs. With regard to any “new” host write request (i.e. write requests received after the event occurs), a write complete signal may be sent to the host device upon the caching of the host write request into a cache of the storage array and the issuance of the unique number, as discussed above. This decreases the latency of the storage array as compared to write-through mode. Once the data from the “new” host write request is in cache, the flushing of the data from the “new” host write requests occurs based on the order in which the new host write requests are received. This allows for consistency to be continually maintained on the persistent storage throughout the “new” host write requests. Thus, this benefit is similar to the benefit of a write-through mode, without the latency delays.

Computing device 100 of FIG. 1, which is described in terms of processors and machine-readable storage mediums, may include structural or functional aspects of storage array 200 of FIG. 2 or storage array 300 of FIG. 3, which are described in terms of engines with hardware and software.

FIG. 2 is a block diagram of a storage array 200. Storage array 200, like computing device 100, may be a web-based server, a local area network server, a cloud-based server, computer networking device, chip set, desktop computer, workstation, or any other processing device or equipment. In some examples, storage array 200 interfaces with a host device 280 and a persistent storage 290. In some examples, storage array 200 interfaces with host device 280 and persistent storage 290 over a communication network (not shown). In some examples, communication network may be an individual network or a collection of many such individual networks interconnected with each other and functioning as a single large network (e.g., the Internet or an intranet). In some examples, communication network may be implemented as a local area network (LAN), wide area network (WAN), etc. In other examples, storage array 200 may be directly coupled to host device 280 and/or persistent storage 290.

Storage array 200 includes a first controller node 210, a second controller node 220, a status engine 230, a flush engine 240, and an IO engine 250. Each of these aspects of storage array 200 will be described below. Other engines and components may be added to storage array 200 for additional functionality.

First controller node 210 of storage array 200 may include a first cache 211. In some examples, first cache 211 is a storage medium of first controller node 210 that allows controller node 210 and storage array 200 quick access to data held in first cache 211. In some examples, first cache 211 may hold a first amount of data. Second controller node 220 of storage array 200 may include a second cache 221. In some examples, second cache 221 is a storage medium of second controller node 220 that allows controller node 220 and storage array 200 quick access to data held in second cache 221.

Each of engines 230, 240, 250, and any other engines, may be any combination of hardware (e.g., a processor such as an integrated circuit or other circuitry) and software (e.g., machine or processor-executable instructions, commands, or code such as firmware, programming, or object code) to implement the functionalities of the respective engine. Such combinations of hardware and programming may be implemented in a number of different ways. A combination of hardware and software can include hardware (i.e., a hardware element with no software elements), software hosted at hardware (e.g., software that is stored at a memory and executed or interpreted at a processor), or at hardware and software hosted at hardware. Thus, for example, the term “engine” may refer to at least one engine or a combination of engines. In some examples, storage drive 200 may include additional engines.

Each engine of storage array 200 can include at least one machine-readable storage medium (for example, more than one) and at least one processing resource (for example, more than one). For example, software that provides the functionality of engines on storage array 200 can be stored on a memory of a computer to be executed by a processing resource of the computer. In some examples, each engine of storage array 200 may include hardware in the form of a microprocessor on a single integrated circuit, related firmware, or other software for allowing microprocessor to operatively communicate with other hardware of storage array 200.

Status engine 230 is an engine of storage array 200 that includes a combination of hardware and software that allows storage array 200 to determine an occurrence of a controller node event in the storage array 200. For example, status engine 230 may receive an error signal from first controller node 210 or second controller node 220 when an event has occurred in either controller node (e.g., when a controller node fails or the batteries associated with both controller nodes are low in charge). As another example, status engine 230 may periodically poll first controller node 210 and/or second controller node 220 to determine the operating status of either controller node or the charge level of a battery associated with either controller node. When status engine 230 determines that an event has occurred in either first controller node 210 and/or the second controller node 220, status engine 230 may send an alert to flush engine 240.

Flush engine 240 is an engine of storage array 200 that includes a combination of hardware and software that allows storage array 200 to freeze the first amount of data that is held in first cache 211 upon the occurrence of the controller node event. For example, flush engine 240 may send a signal or command to first controller node to freeze the first amount of data in first cache 211. Flush engine 240 also allows storage array 200 to flush the first amount of data to persistent storage 290. For example, flush engine 240 may send a signal or command to first controller node to flush the first amount of data in first cache 211. The first amount of data is data that already existed in first cache 211 prior to the occurrence of the controller node event Thus, the first amount of data represents data from “old” host write requests.

In some examples where storage array is a mirroring storage array, an amount of data (e.g., “a first amount of data” or “a second amount of data”) includes already-existing data that is uncorrupted and, due to the event occurring in the storage array, is no longer duplicated on another controller node. In examples where storage array 200 is a mirroring storage array, any data that is temporarily held in first cache 211 is duplicated in second cache 221 of second controller node 220 and any data that is temporarily held in second cache 221 is duplicated in first cache 211 of first controller node 210. This allows for the failure of second controller node or first controller node without losing data. Thus, first cache 211 may hold N data and second cache 221 may hold N′ data, where N′ is a duplication of N data. Likewise, second cache 221 may hold N+1 data and first cache may hold N+1′ data, where N+1′ is a duplication of N+1 data.

When the event that has occurred is a failure of a controller node in the storage array 200 (e.g., failure of second controller node 221), the cache of second controller node 221 is inaccessible. Thus, the “first amount of data” on first cache 211 includes N and N+1′. N+1′ is included even though it is a duplication of N+1 because N+1 on second cache 221 is no longer accessible. In examples where the event that has occurred is a low charge of the batteries associated with first controller node 220 and second controller node 221, the “first amount of data” on first cache 211 is N and not N+1′ because N+1 on second cache 221 is still accessible. Accordingly, in these examples, flush engine 240 allows storage array 200 to freeze the first amount of data (N) held in first cache 211 and a second amount of data (N+1) held in second cache 221 upon the occurrence of the controller node event and to flush the first amount of data and the second amount of data to persistent storage 290. The second amount of data, similar to the first amount of data, is generated before the occurrence of the controller node event.

IO engine 250 is an engine of storage array 200 that includes a combination of hardware and software that allows storage array 200 to receive a first host write request from host device 280. The first host request may comprise first host data. This write request may, for example, be a request from host device 280 to store first host data in the persistent storage 290. The first host write request is received after the occurrence of the controller node event. IO engine 250 also allows storage array 200 to assign a number to the first host write request. The number represents an order in which the first host write request is received by the storage array. IO engine 250 may also allow storage array 200 to assign additional numbers to additional host write requests that may come after first host write request, for example, second host write request, third host write request, etc. These numbers represent the order in which the host write requests are received by storage array 200 and are universal and unique across the storage array 200. For example, in situations where the event is low charge of the batteries associated with both first controller node 210 and second controller node 220, both first controller node 210 and second controller node 220 are functioning and still able to process “new” host write requests from host device 280. Host device 280 may send three write requests, one at time T, one at time T+1, and another at time T+2. The T and T+1 write request may be processed by first controller node 210. The T+3 write request may be processed by second controller node 220. IO engine 250 allows storage array 200 to assign a number 1 to the T write request, a number 2 to the T+2 write request, and a number 3 to the T+3 write request, even though the T+3 write request is the first one processed by second controller node 220 after the occurrence of the event.

In some examples, first cache 211 is also to temporarily hold host data from first host write request, and any other host data from additional host write requests. In examples where the event is a low charge of the batteries associated with both first controller node 210 and second controller node 220, second cache 221 may likewise temporarily hold host data from host write requests. The host data from the host write requests may be held at the same time that the first amount of data and/or the second amount of data is held in first cache and/or second cache. However, as describe below in relation to flush engine 240, the first amount of data is flushed before the host data from the host write request is flushed.

Flush engine 240 allows storage array 200 to flush host data from cache to persistent storage 290, based, at least in part, on the numbers that are assigned to the host write requests by IO engine 250. This allows for 10 consistency to be maintained on persistent storage 290. For example, in situations where the event is a failure of second controller node 220, all host write requests occurring after the event is processed by first controller node 210. IO engine 250 assigns the host write requests each a number that represents an order in which they are received by the storage array 210. The data associated with the host write requests are temporarily stored in first cache 211. Flush engine 240 then signals first controller node 210 to flush the host write requests according to the number that they are assigned.

In another example, in situations where the event is a low charge of the batteries associated with both first controller node 210 and second controller node 220, some host write requests occurring after the event may be processed by first controller node 210 and some host write requests occurring after the event may be processed by second controller node 220. IO engine 250 assigns the host write requests each a number that represents an order in which they are received by the storage array. The data associated with the host write requests are temporarily held in either first cache 211 or second cache 221. The cache in which the data is first held is the cache or controller node that “owns” the data. The data may also be duplicated to the other controller node. This duplicated data, however, is not flushed unless the controller node that “owns” the data fails and cannot flush the data itself. Flush engine 240 then signals first controller node 210 and second controller node 220 to flush the data according to the number that was assigned to the host write request by IO engine 250. For example, if there are three host write requests with numbers 6, 7, and 8 assigned, the data associated with number 6 is flushed first, the data associated with number 7 is flushed next, and the data associated with number 8 is flushed last.

Storage array 200 of FIG. 2, which is described in terms of engines containing hardware and software, may include one or more structural or functional aspects of computing device 100 of FIG. 1 or storage drive 300 of FIG. 3.

FIG. 3 is a block diagram of a storage array 300 with multiple controller nodes 310, 320, 370, and 371 and batteries associated with each controller node. While there are four controller nodes in FIG. 3, storage array 300 is not limited to the four controller nodes. For example, storage array 300 may have two controller nodes, six controller nodes, eight controller nodes, etc.

First controller node 310 comprises first cache 311 and battery 312. Second controller node 320 comprises a second cache 321 and a battery 322. Battery 312 is associated to first controller node 310 and provides a back-up power supply to cache 311 in the event the main power supply to first controller node 310 is lost Battery 322 is similarly associated to second controller node 320 and provides a back-up power source to cache 321 in the event the main power supply to second controller node 320 is lost. Thus, battery 312 and battery 322 allow caches 311 and 321 to flush the data temporarily held in the caches in the event of a power outage. First controller node 310 is otherwise similar to first controller node 210 and second controller node 320 is otherwise similar to second controller node 220. Third controller node 370 and fourth controller node 371 may include similar components found in first controller node 310 and second controller node 320. For example, third controller node 370 may include a cache and a battery. Additionally, fourth controller node 370 may include a cache and a battery.

The controller nodes of storage array 300 may process host write requests from host devices 380A, 380B, 380C, and 380D. While four host devices are shown, storage array 300 is not limited to communicating to four host devices. Storage array 300 may also interface with five persistent storages 390A, 390B, 390C, 390D, and 390E. While five persistent storages are shown, storage array 300 is not limited to communicating with five persistent storages.

Storage array 300 comprises a status engine 330, a flush engine 340, an IO engine 350, and a user input engine 360. Status engine 330 is similar to status engine 230 and determines an occurrence of an event in first controller node 310, second controller node 320, third controller node 370, and fourth controller node 371. It may do this by receiving an alert signal from the individual controller node when an event occurs in the controller node. It also may do this by periodically polling the individual controllers. “Event” as described above is also applicable here. For example, an event in storage array 300 may be the failure of at least one storage controller node. As another example, an event in storage array 300 may be a low charge of a battery that is associated with at least two of the controller nodes (e.g., two controller nodes, three controller nodes, or all four controller nodes). Accordingly, an event has occurred in storage array 300 when, for example, battery 312's charge is depleted and battery 322's charge is depleted, even though the charge of batteries associated with third controller node and fourth controller node are not depleted.

User input engine 360 is an engine of storage array 300 that includes a combination of hardware and software that allows storage array 300 to receive a user input regarding a mode of operation of the storage array 300 before the occurrence of an event and upon the occurrence of an event. For example, a user may indicate that, before the occurrence of an event, the storage array 300 is to operate in write-back mode and that, after the occurrence of an event, the storage array 300 is to continue to operate in write-back mode. The user may also indicate that after the occurrence of an event, the storage array is to switch from write-back mode to write-through mode. In some examples, user input 360 may be communicatively linked to a user input device, such as a screen, keyboard, mouse, etc.

Flush engine 340 is similar to flush engine 240. Responsive to a determination that an event has occurred, flush engine 340 may allow storage array 300 to signal to each controller node to freeze the data that is already-existing (i.e. existing prior to the occurrence of the event) in the cache of each controller node. Thus, first controller node 310 may freeze the data that is already-existing in first cache 311, second controller node 320 may freeze the data that is already-existing in second cache 321, and third controller node 370 and fourth controller node 371 may freeze the data that is already-existing in their respective cashes. Flush engine 340 may also allow storage array 300 to signal to each controller node to flush the already-existing data in their respective caches to persistent storage. In some examples, this flush does not include duplicated data on the cache that is “owned” by another controller node. In other examples, this flush includes duplicated data that is “owned” by another controller node because the controller node that owns the data has failed or owning controller node cannot flush its cache for some other reason.

IO engine 350 is an engine of storage array 300 that includes a combination of hardware and software that allows storage array 300 to receive host write requests from at least one of the host devices 380A-380D. In some examples, IO engine 350 is affected by user input engine 360. For example, when the user indicates that storage array 300 is to be operated in a write-back mode after the occurrence of an event, IO engine 350 allows storage array 300 to assign 10 ordering numbers to the host write requests that are received after the occurrence of the controller node event. IO engine 350 also allows storage array 300 to send a host write complete signal to the host device that initiated the write request upon the data in the host write request being held in a cache of the storage array 300. The numbers that are assigned to the host write requests occurring after the event are universal and unique across the controller nodes in storage array 300 and reflect the order in which the host write requests are received by the storage array, not by an individual controller node.

In other examples, when the user indicates that storage array 300 is to be operated in a write-through mode after the occurrence of the event, IO engine 350 may not assign a number to host write requests received after the occurrence of the controller node event. Additionally, in these examples, IO engine 350 allows storage 300 to send a host write complete signal upon a storage of the data in the host write request into persistent storage.

In some examples, flush engine 340 may be affected by user input engine 360. For example, when the user indicates that storage array 300 is to be operated in a write-back mode after the occurrence of an event, flush engine 340 may allow storage array 300 to flush host data (originating from host write requests occurring after the occurrence of the event) from cache based, at least in part, on the number assigned to the host write requests by IO engine 350. Thus, for example, there may be 5 host write requests with number 10, 11, 12, 13, 14. Numbers 10 and 14 host write requests may be cached on first cache 311, number 11 may be cached on second cache 321, and numbers 12 and 13 may be cached on the cache in third controller node 370. In this example, fourth controller node 371 may be experiencing a failure (and thus was not able to process any of the “new” host write requests occurring after the event). Accordingly, number 10 (owned by first controller node) is flushed first, number 11 (owned by second controller node 320) is flushed second, number 12 (owned by third controller node 370) is flushed third, number 13 (owned by third controller node 370) is flushed fourth, and number 14 (owned by first controller node) is flushed fifth.

Storage array 300 of FIG. 3, which is described in terms of engines containing hardware and software, may include one or more structural or functional aspects of computing device 100 of FIG. 1 or storage drive 200 of FIG. 2.

FIG. 4 illustrates a flowchart for an example method 400 to operate a storage array in write-back mode upon an occurrence of an event. Although execution of method 400 is described below with reference to storage array 200 of FIG. 2, other suitable systems for execution of method 400 may be utilized (e.g., computing device 100 or storage array 300). Additionally, implementation of method 400 is not limited to such examples and method 400 may be used for any suitable device or system described herein or otherwise.

At 410 of method 400, IO engine 250 operates storage array 200 in a first mode. As discussed above, an engine of storage array 200 can include at least one processing resource. Accordingly, in some examples, 410 of method 400 (and other steps of method 400) may be performed by the processing resource of the specified engine. In some examples, the first mode is a write-back mode where write request complete signals are sent to the host device when the data associated with the host write request is temporarily held in a cache of storage array 200. Write-back mode allows for lower latency with regard to write requests because there is no extra time for the data associated with the host write request to be flushed (i.e. committed) to a persistent storage. At 420 of method 400, status engine 230 determines an occurrence of an event in first controller node 210 of storage array 200. At 430 of method 400, flush engine 240 may freeze an amount of data in a cache of the storage array 200. The cache may be first cache 211 of first controller node 210 and/or second cache 221 of second controller node 220. For example, when the event is a failure of first controller node 210, first cache 211 is inaccessible. Thus, flush engine 240 freezes an amount of data in second cache 221. As another example, when the event is a low charge of a batteries associated with both first controller node 210 and second controller node 220, flush engine 240 freezes an amount of data in first cache 211 and an amount of data in second cache 221. The amount of data that is frozen is generated prior to the occurrence of the event. In other words, it is data from host write requests that occurred prior to the occurrence of the event (i.e. “old” host write requests). At 440 of method 400, flush engine 240 may flush the amount of data frozen to persistent storage 290.

At 450 of method 400, IO engine 250 may continue the operation of storage array 200 in write-back mode after the occurrence of the event. This allows for lower latency and continued high performance of storage array 200. At 460, IO engine 250 receives a first write host request from host device 280. The first write host request may comprise first host data. At 470, the first host data may be held in either first cache 211 or second cache 221. At this point, IO engine 250 assigns a number to the first write host request and sends a write request complete signal to host device 280. This allows host device 280 to initiate another host write request, if needed. At 480 of method 400, flush engine 240 flushes the first host data to persistent storage 290. As discussed above, the flushing of the first host data to persistent storage 290 is after the flushing of the amount of data in the cache that was existing prior to the occurrence of the event. In some examples, functionalities described herein in relation to FIG. 4 may be provided in combination with functionalities described herein in relation to any of FIGS. 1-3, and 5. Although the flowchart of FIG. 4 shows certain functionalities as occurring in one step, the functionalities of one step may be completed in at least one step (e.g., in multiple steps).

FIG. 5 illustrates a flowchart for an example method 500 of flushing new host write requests after the occurrence of a storage array event. Although the execution of method 500 is described below with reference to storage array 300 of FIG. 3, other suitable systems for execution of method 500 may be utilized (e.g., storage array 200 or computing device 100). Additionally, implementation of method 500 is not limited to such examples and method 500 may be used for any suitable device or system described herein or otherwise.

At 510 of method 500, IO engine 350 operates storage array 300 in write-back mode. As discussed above, an engine of storage array 300 can include at least one processing resource. Accordingly, in some examples, 510 of method 500 (and other steps of method 500) may be performed by the processing resource of the specified engine. At 521, status engine 330 determines if there is a failure of a controller node in storage array 300. This may include a failure of first controller node 310, a failure of second controller node 320, a failure of third controller node 370, or a failure of fourth controller node 371. Responsive to a determination that there is not a failure of a controller node, method 500 proceeds to 522. Responsive to a determination that there is a failure of a controller node, method 500 proceeds to 521A.

At 521A, IO engine 350 determines if IO consistency can be maintained in the current mode (e.g., write-back mode) on the surviving controller nodes based on the failure of the controller node. For example, in a mirroring storage array where data owned by failed controller node is mirrored on another controller node, IO engine 350 determines that IO consistency may be maintained. For example, in a storage array that is not mirroring and data owned by a failed controller node is not mirrored on another controller node, IO engine 350 may determine that IO consistency cannot be maintained. Responsive to a determination that IO consistency may be maintained, method 500 proceeds to 522. Responsive to a determination that IO consistency may not be maintained, method proceeds to 530.

At 522 of method 500, status engine 330 determines if a battery associated with at least two controller nodes are low in charge. Responsive to a determination that the batteries are charged, method proceeds to 510. Responsive to a determination that there is a low charge in at least two batteries, method 500 proceeds to 530.

At 530 of method 500, flush engine 340 freezes an amount of data that is already in the cache of storage array 300. This includes freezing data in first cache 311, data in second cache 321, data in the cache of third controller node 370, and data in the cache of fourth controller node 371. In situations where there was a failure of a controller node at 521, the data in the cache of the failed controller node is not frozen because the controller node is inaccessible. At 540 of method 500, flush engine 340 flushes the amount of data frozen in 530 to a persistent storage. This is similar to 440 of method 400. At 551 of method 500, user input engine 360 determines if there is an indication by the user that the write-back operation of storage array 300 is to change to write through mode. Responsive to a determination that the operating mode of storage array 300 is to be changed to write-through mode, method 500 proceeds to 552. At 522, IO engine 350 changes the operation of storage array 300 to write-through mode.

Responsive to a determination that the operating mode of storage array 300 is to stay in write-back mode, method 500 proceeds to 553. At 533, IO engine 350 maintains the operation of storage array 300 in write-back mode. At 561 of method 500, IO engine 350 receives a first host write request from one of host devices 380A-380D. The first host write request comprises first host data. The first host write request occurs after the occurrence of the event. At 562, IO engine 350 assigns a first number to the first host write request received at 561. At 563, the first host data is held in a cache of a controller node in storage array 300. In examples, where the event is batteries with low charges (as determined in 522 of method 500), the cache in which the first host data is held may be first cache 311, second cache 321, the cache of third controller node 370, or the cache of fourth controller node 371. At 564 of method 500, IO engine 350 may confirm the write request to the host device that initiated the first host write request by sending a write request complete signal to the host device of the first host write request. At 565 of method 500, IO engine 350 receives a second host write request from any one of host device 380A-380D. The second host request comprises second host data.

At 571, IO engine 350 assigns a second number to the second host write request. The second number relative to the first number assigned at 562 reflects the relative order in which the host write requests are received by storage array 300. At 572, the second host data is temporarily held in a cache of storage array 300. This is similar to a manner in which first host data is held at 563. At 581 of method 500, IO engine 350 may confirm the write request to the host device that initiated the second host write request by sending a write request complete signal to the host device of the second host write request. At 582 of method 500, flush engine 340 flushes the first host data and the second host data from a cache in storage array 300 to a persistent storage. The flushing of the first host data and the second host data is based, at least in part, on the first number and the second number.

In some examples, functionalities described herein in relation to FIG. 5 may be provided in combination with functionalities described herein in relation to any of FIGS. 1-4. Although the flowchart of FIG. 5 shows certain functionalities as occurring in one step, the functionalities of one step may be completed in at least one step (e.g., in multiple steps). Additionally, although the flowchart of FIG. 5 shows a specific order of performance of certain functionalities, method 500 is not limited to that order. For example, some of the functionalities shown in succession in the flowchart may be performed in a different order, may be executed concurrently or with partial concurrence, or a combination thereof. For example, 572 and 563 may be performed concurrently.

All of the features disclosed in this specification (including any accompanying claims, abstract and drawings), and/or all of the elements of any method or process so disclosed, may be combined in any combination, except combinations where at least some of such features and/or elements are mutually exclusive. In the foregoing description, numerous details are set forth to provide an understanding of the subject matter disclosed herein. However, examples may be practiced without some or all of these details. Other examples may include modifications and variations from the details discussed above. The appended claims may cover such modifications and variations.

What is claimed is:

1. A non-transitory machine-readable storage medium comprising instructions that, when executed, cause a processing resource to:
receive a notification about an event occurring in a storage array;
in response to receiving the notification, freeze a cache of the storage array and flush data in the cache to a persistent storage, wherein the data in the cache is stored in the cache prior to the event;
receive first data in a first host write request from a host device, wherein the first host write request is received after the event;
send a write request complete signal to the host device; and
flush the first data to the persistent storage, wherein the first data is flushed after the data in the cache is flushed.

2. The storage medium of claim 1, comprising instructions that, when executed, cause the processing resource to:
assign a first unique identifier to the first host write request.

3. The storage medium of claim 2, comprising instructions that, when executed, cause the processing resource to:
receive second data in a second host write request, wherein the second host write request is generated after the event; and
assign a second unique identifier to the second host write request, wherein a relationship between the first identifier and the second identifier indicate an order in which the first host write request and the second host write request are received by the storage array.

4. The storage medium of claim 3,
wherein the cache of the storage array comprises a first cache in a first controller node and a second cache in a second controller node; and
comprising instructions that, when executed, cause the processing resource to:
cache the first data into the first cache before flushing the first data to the persistent storage; and
cache the second data into the second cache.

5. The storage medium of claim 4, comprising instructions, that when executed, cause the processing resource to:
flush the second data to the persistent storage, wherein an order of the flushing of the second data in relation to the flushing of the first data is based on the first unique identifier and the second unique identifier.

6. The storage medium of claim 1, wherein the notification is regarding a failure of a first controller node in the storage array.

7. The storage medium of claim 1, wherein the notification is regarding a low charge of batteries associated with a first controller node and a second controller node in the storage array.

8. A storage array comprising:
a first controller node;
a second controller node;
a status engine to determine an occurrence of a controller node event in the storage array;
a first cache to hold a first amount of data, wherein the first amount of data is held in the first cache before the occurrence of the controller node event;
a flush engine to freeze the first amount of data in the first cache upon the occurrence of the controller node event and to flush the first amount of data to a persistent storage; and
an IO engine to receive a first host write request comprising first host data and to assign a first unique number to the first host write request, wherein the first host write request is received after the occurrence of the controller node event.

9. The storage array of claim 8, wherein the controller node event is a failure of the second controller node.

10. The storage array of claim 8, wherein the storage array comprises a first battery for the first controller node; and a second battery for the second controller node; and wherein the controller node event is a low charge of the first battery and a low charge of the second battery.

11. The storage array of claim 8, wherein the first cache is to hold the first host data.

12. The storage array of claim 8, wherein the flush engine is to flush the first host data to the persistent storage after the flushing of the first amount of data.

13. The storage array of claim 8, wherein the IO engine is to receive a second host write request comprising second host data and to assign a second unique number to the second host write request.

14. The storage array of claim 13, wherein the flush engine is to flush the first host data and to flush the second host data to the persistent storage based on the first unique number and the second unique number.

15. The storage array of claim 14, wherein the first unique number and the second unique number correspond to an order in which the first host write request and the second host write request are received by the storage array.

16. A method comprising:
operating, with a processing resource, a storage array in a first mode;
determining, with the processing resource, an occurrence of controller node event in the storage array;
in response to determining the occurrence of the event, freezing, with the processing resource, an amount of data in a cache, wherein the amount of data is stored in the cache prior to the occurrence of the event;
flushing, with the processing resource, the amount of data in the cache to a persistent storage;
maintaining, with the processing resource, the operation of the storage array in the first mode, wherein the first mode is a write-back mode;
receiving, with the processing resource, a first host write request comprising first host data;
holding, with the processing resource, the first host data in the cache; and
flushing, with the processing resource, the first host data to the persistent storage.

17. The method of claim 16, comprising;
assigning, with the processing resource, a first unique number to the first host write request;
receiving, with the processing resource, a second host write request comprising second host data; and
assigning, with the processing resource, a second unique number to the second host write request.

18. The method of claim 17, comprising flushing, with the processing resource, the second host data to the persistent storage, wherein flushing of the second host data in relation to the flushing of the first host data is based on the first unique number and the second unique number.

19. The method of claim 16, wherein the event is a failure of a first controller node in the storage array.

20. The method of claim 16, wherein the event is a low charge of a battery associated with at least two controller nodes of the storage array.
